(19) United States
(12) Patent Application Publication
(10) Pub. No.: US 2026/0281647 A1
(43) Pub. Date: Sep. 17, 2026

(54) Optimized processing for reducing channels of a stereophonic audio signal

(71) Applicant: ORANGE, Issy-les-Moulineaux (FR)

(72) Inventors: Stéphane RAGOT, CHATILLON (FR); Alexandre GUERIN, CHATILLON (FR); Arnaud LEFORT, CHATILLON (FR)

(21) Appl. No.: 19/473,275

(22) PCT Filed: Apr. 10, 2024
(86) PCT No.: PCT/EP2024/059646

§ 371 Date: Oct. 7, 2025

(30) Foreign Application Priority Data
Apr. 13, 2023 (FR) FR2303719
Apr. 27, 2023 (FR) FR2304288
May 23, 2023 (FR) FR2305109

(51) Int. Cl. H04S 7/00; H04S 1/00

(52) U.S. Cl. CPC H04S 7/30; H04S 1/007; H04S 2400/03

(57) ABSTRACT

A method for downmixing a stereophonic signal in order to obtain a monophonic signal comprising, for a current frame. The method includes: a first step of selecting a downmixing operation from two procedures which use filtering of the stereophonic signal and rephasing of the signals, the selection being made according to a phase indicator, representative of a measure of a degree of phase opposition between the frequency components of the channels of the stereo signal; and a second step of selection between one of the two procedures, selected at the end of the first selection step, and a downmixing procedure without rephasing, the selection being made according to the value of an energy ratio between the channels of the stereo signal.

### TECHNICAL FIELD

The present invention relates to the general field of processing audio signals. The invention relates, in particular, to downmixing of a multichannel audio signal. Downmixing of a stereophonic signal to a monophonic signal is of particular interest.

This type of processing is generally applicable in the field of audio technologies, and more specifically in the field of audio coding, whether it is in the coding or decoding step.

### PRIOR ART

Downmixing consists in deducing, on the basis of a combination of the C channels of a multichannel signal x, a signal y consisting of a smaller number D of channels. In practice, this consists in defining a function ƒ(⋅) such that:

$$m ( n ) = [ \begin{matrix}{m}_{1} ( n ) \\ ⋮ \\ {m}_{D} ( n )\end{matrix} ] = f ( x ( n ) ) = f ( [ \begin{matrix}{x}_{1} ( n ) \\ ⋮ \\ {x}_{C} ( n )\end{matrix} ] ) ,$$

with D<C and n representing a temporal index of the input and output signal.

In this invention, the particular case D=1 and C=2 is of interest; reference will, then, be made to stereo-to-mono downmixing or simply to mono downmixing. In the case C=2, reference is made to 2-channel content or signal, which may be stereo content or binaural content, where channel 1 (x₁) is referenced as the left channel (Left), and channel 2 (x₂) as the right channel (Right). Below, the stereo case will be seen as a general 2-channel signal, including the binaural case in order to avoid repeating the two terms, even if technically a binaural signal has specific characteristics. In the case of the signal y obtained after downmixing, reference is made to a monophonic or mono signal, which will be noted m(n), in the time domain, or M(k), in the frequency domain, below.

These stereo signals may result from capture by a pair of stereo microphones or binaural capture, or even from artistic mixing of audio tracks.

There is a certain number of pairs of microphones which make it possible to create stereo content. Among the most popular, mention may be made of the XY pair composed of 2 cardioid microphones exhibiting a difference in orientation angle of between 90° and 135°. The MS (mid-side) pair is another very widespread pair composed of a microphone of cardioid directivity and of a second microphone, referred to as a “figure of 8” microphone, oriented at 90°. By combining these 2 mics (sum/difference), the left and right stereo content channels may be created. These pairs are referred to as coincident pairs, that is to say that the microphone capsules do not exhibit a delay between them, the spatialization being perceived by the difference in sound intensity between the left channel and right channel.

Another category of pairs referred to as phase stereophony pairs consists in using microphones which are distant from one another, thus creating a phase difference between the channels for the sources located closer to one of the mics. The most known is the AB pair, which utilizes 2 omnidirectional microphones spaced apart by a few centimeters to several meters. Another very widespread pair is the ORTF pair, which utilizes both a phase difference through a spacing of 17 cm of the microphones and an amplitude difference through cardioid directivities (the microphones exhibit an angle of around 90°). The binaural pair consists in placing omnidirectional microphones in the ears of a person or of an artificial head: this type of device makes it possible to create binaural content natively, which may be listened to through the headset.

Stereo content also includes speech and audio signals resulting from audio mixing or audio postproduction (for example, channels stored on a CD or a DVD, or broadcast over the Internet).

There are also other procedures for creating stereo content, which are not reviewed here.

The simplest procedure for creating a signal reduced by downmixing is that referred to as passive downmixing. It consists in taking an average of the left channel and right channel of the stereo signal such that:

$$m ( t ) = \frac{{x}_{1} ( t ) + {x}_{2} ( t )}{2}$$

or, in the frequency domain:

$$M ( t , k ) = \frac{{X}_{1} ( t , k ) + {X}_{2} ( t , k )}{2}$$

where Xᵢ(t,k),i=1,2 is the fast Fourier transform xᵢ(t) (FFT), k being the index of the frequency and t the index of the frame:

$${X}_{i} ( t , k ) = {\sum }_{l = 0}^{L - 1} w ( l ) \cdot {\check{x}}_{i} ( t , l ) {e}^{- \frac{j 2 π l k}{N}} , for any k ∈ \{ 0 , … , N - 1 \}$$

where j is the imaginary number such that j=\sqrt{−1}, t is the index of the frame, 1 is the temporal index in the current frame, N the size of the FFT, w(⋅) a sine or Hann or other apodization window of size L, adapted to the size of the frame, and x̌ᵢ(t,l)=x₁(t,l). This definition extends to the case where N>L and x̌ᵢ(⋅) is an augmented version of xᵢ(t) with 0s (0-padding).

This passive downmixing procedure, which is very simple, operates well in situations in which the right channel and left channel are in phase. However, in situations in which the microphones are not coincident and exhibit phase differences, such mixing generates comb filtering, which is manifested by coloration of the original signal. This is due to the fact that, depending on the spacing of the microphones, on the position of the source with respect to the pair of microphones and on the frequency, the left channel and right channel of the same source may be either in phase, as depicted in FIG. 1a, or in phase opposition as depicted in FIG. 1b. Thus, when downmixing, the left signal and right signal will either add (constructive interference) or cancel out (destructive interference), thus creating variations in level and effects of coloration of the reduced signal m(t). The coloration comes from the effect of comb filtering: the effects of constructive and destructive interference are manifested in different frequency bands, thus modifying the balance and thus the tone of the signal resulting from the downmixing with respect to the original.

In order to correct this defect of intensity level according to frequencies, the downmixing of the e-AAC+ codec implements level correction γ(k) which ensures that the energy level of the reduced signal, in each frequency band, remains comparable to the original one:

$$M ( k ) = γ ( k ) \cdot \frac{{X}_{1} ( k ) + {X}_{2} ( k )}{2} ,$$

with

$$γ ( k ) = \sqrt{\frac{{\vert {X}_{1} ( k ) \vert}^{2} + {\vert {X}_{2} ( k ) \vert}^{2}}{0.5 {\vert {X}_{1} ( k ) + {X}_{2} ( k ) \vert}^{2}}}$$

This approach makes it possible to compensate, to a certain extent, for the drop in intensity of the downmixing. However, this compensation leads to overamplifications when the signals are close to phase opposition: also, in practice, the correction factor γ(k) is limited to a maximum value (for example, an upper limit of 2).

FIG. 7 describes a procedure for reducing stereo channels to mono which is integrated into the public candidate IVAS codec which is available at the address: https://forge.3gpp.org/rep/ivas-codec-pc/ivas-codec/-/tree/main

The signal x(m) with 2 input channels, where m is the index of the interleaved samples, is deinterleaved (block 701) to find both the left channel and the right channel. Next, a frequency analysis with windowing and Fourier transform (blocks 702 and 703) is performed in order to obtain the spectra of the 2 channels, and the intercorrelation on the basis of the phase spectra is estimated (block 704) before determining the time difference between the channels (here labeled ITD even though it is formally an ICTD between 2 channels) by searching for a peak (block 705); the block 705 also provides the correlation level R* corresponding to the ITD.

The mixing factor g is then determined as follows (block 706):

$$g = \{ \begin{matrix}\frac{1}{2} - \frac{{R}^{*}}{2} & τ > 0 \\ \frac{1}{2} + \frac{{R}^{*}}{2} & τ < 0 \\ \frac{1}{2} & τ = 0\end{matrix}$$

where g represents the mixing factor and r is the inter-channel time difference (incorrectly called the ITD). Thus, the 2 channels are combined into a mono signal in the block 706 according to this factor g, with smoothing of the value of the factor applied sample by sample at the start of each frame after the block 707:

m(n)=γ(n)x₁(n)+(1−γ(n))x₂(n),
where γ(n) is the factor derived from g after temporal smoothing with the gain of the previous frame.

Next, the energies of the left channel x₁(n) and right channel x₂(n) and of the mono signal m(n) are determined (blocks 708, 709, 710). The left channel and right channel are separately reinjected (added), in the blocks 713 and 715, into the mono signal resulting from the block 706 depending on energy compensation determined in the block 711 with respective scale factors defined in the blocks 712 and 713.

These procedures, in addition to the coloration of the signal resulting from the downmixing, linked to the imperfectly corrected comb filtering, suffer from surplus reverberation linked to the summation of signals when the input channels are out of phase, and from a “click” artifact when channels are reinjected punctually into a single frame. Compensating for a delay which is identical for all the frequencies is not realistic, this delay being linked to the various sources composing the content. In practice, this leads, besides additional coloration, to a potential loss of intelligibility of the sources, which defect level compensation cannot correct.

Other downmixing approaches seek to avoid the aforementioned defects. The principle of these procedures is to rephase the left signal and right signal before they are summed. In the document entitled “A stereo to mono downmixing scheme for MPEG-4 parametric stereo encoder” by Samsudin, E. Kurniawati, N. Boon Poh, F. Sattar, S. George, in Proc. ICASSP, 2006, a procedure which consists in applying, in the frequency domain, a phase shift φ to one of the channels, generally the right one, in order to rephase it with the left channel, is proposed, such that:

$$M ( k ) = \frac{{X}_{1} ( k ) + {X}_{2} ( k ) \cdot {e}^{- j φ ( k )}}{2}$$

The ideal phase shift is given by what is called here the IPD (inter-channel phase difference):

$$IPD ( k ) = ∠ ( {X}_{1} ( k ) \cdot {X}_{2}^{*} ( k ) )$$

where X* is the conjugate of X and ∠ indicates the phase of the complex operand.

It is calculated in the frequency domain: this makes it possible to rephase the spectral components of various sources, a source with its own IPD being able to be preponderant in a frequency band k, while another source with a different IPD may be preponderant at another frequency k′.

In the case of the MPEG4 codec described in the Samsudin document cited above, the IPD applied is that estimated by averaging over a Bark band and not the IPD calculated for each frequency band, the latter proving to be particularly noisy and variable from one frame to the next. In addition, this procedure takes the left channel as phase reference and, if the phase of this channel is poorly conditioned, the downmixing has a degraded quality.

In the published patent application WO2017103418, a downmixing procedure which mixes the procedure proposed by Samsudin and passive downmixing is proposed. Notably, it proposes an ISD (inter-spectral distance) indicator which makes it possible to choose, frequency band by frequency band, which is the most suitable procedure for rephasing the signals:

$$ISD ( k ) = \frac{\vert {X}_{1} ( k ) - {X}_{2} ( k ) \vert}{\vert {X}_{1} ( k ) + {X}_{2} ( k ) \vert}$$

This indicator makes it possible to measure whether the signals are in phase (ISD<1), that is to say with a phase difference or IPD in the interval

$$[ - \frac{π}{2} , \frac{π}{2} ] ,$$

or rather in phase opposition (ISD>1), i.e. with an IPD in the interval

$$[ \frac{π}{2} , \frac{3 π}{2} ] .$$

When they are in phase opposition, a high ISD value is synonymous with a comparable level between the left channel and the right channel and rephasing is important to avoid the effects of coloration and of dropout. By contrast, an ISD value which is close to 1 is representative of one channel which is preponderant with respect to the other; in this latter case, rephasing is unimportant, since downmixing is almost equal to the preponderant signal. It is, however, important to avoid modifying the phase of the right channel if the latter is preponderant. Thus, in this patent application, a following downmixing selection mechanism is proposed:

$$\{ \begin{matrix}M ( k ) = \frac{{X}_{1} ( k ) + {X}_{2} ( k ) \cdot {e}^{- jIPD ( k )}}{2} , & if ISD ( k ) > 1.3 \\ M ( k ) = \frac{{X}_{1} ( k ) + {X}_{2} ( k )}{2} , & if ISD ( k ) < 1.3\end{matrix}$$

The passive downmixing proposed in the aforementioned patent application, for situations of low ISD, sometimes introduces increased reverberation.

Moreover, it has been observed that in certain situations in which the signals are somewhat in phase, i.e. when ISD(k)<1.3, and in particular when the channels are highly imbalanced (source mainly on the left or on the right), a potentially dislikable loss of timbre occurs, and it may therefore be important in such cases to keep the signal intact, i.e. to not apply a phase shift.

Moreover, the procedure proposed in the aforementioned patent application requires the application of a processing operation in the frequency domain, the reduced signal being reconstructed on the basis of the inverse short-time Fourier transform (STFT) of the signal M(t,k). This type of filtering generates a circular convolution which creates audible artifacts: echo, pre-echo and static. In order to mask these artifacts, an implementation with frame overlap associated with suitable windowing (analysis and/or synthesis window) guaranteeing reconstruction of the filtered signal may be used. Generally, this overlap is not compatible with the operation of the audio coders which work with the adjacent frames, i.e. without overlap; in addition, this type of reconstruction leads to a delay, generally of half a frame, which is the conventional overlap, which is not acceptable for a coder which has strong constraints in terms of latency.

Another overlap-and-add (OLA) implementation is also possible: this procedure requires a step of 0-padding the signals and the filters in order to avoid circular convolution. However, tests show that with such filters, the phase of which varies very rapidly from one frame to the next, an OLA approach does not make it possible to mask artifacts completely at the transition of certain frames, the artifacts then remaining audible.

There are also prior-art procedures in which downmixing is obtained by switching, for example in the frequency domain in the published patent application WO2017103418, different downmixing procedures. In this case, it is important to ensure that switching takes place “seamlessly”, that is to say without discontinuities or differences in levels between procedures to avoid artifacts.

### Disclosure of the Invention

The invention aims to improve the prior art.

To this end, the invention relates to a method for downmixing a stereophonic signal in order to obtain a monophonic signal comprising, for a current frame:
a first step of selection of a downmixing operation from two procedures which use filtering of the stereophonic signal and rephasing of the signals, the selection being made according to a phase indicator, representative of a measure of a degree of phase opposition between the frequency components of the channels of the stereo signal,
a second step of selection between one of the two procedures, selected at the end of the first selection step, and a downmixing procedure without rephasing, the selection being made according to the value of an energy ratio between the channels of the stereo signal.

These selection steps thus make it possible to determine the type of downmixing most suited to the characteristics of the stereophonic signal.

In one embodiment, the energy ratio between the channels of the stereo signal is calculated per frequency band, the second selection step being performed per frequency band.

Thus, only the relevant frequency bands, the energy ratio of which exceeds a threshold, apply downmixing without rephasing to achieve a finer adaptation.

In one particular embodiment, the downmixing operation without rephasing is selected for relevant frequency bands only in the case where the number of relevant frequency bands exceeds a threshold.

This makes it possible to avoid excessive fluctuations from one frame to another.

In one embodiment, a third step of selection between one of the two procedures selected at the end of the second selection step and a third downmixing procedure which does not use filtering of the stereophonic signal is performed, said selection being made depending on:
a presence or absence of at least one transition in the stereophonic signal, or
a quality level of the filtering of the stereophonic signal used when implementing a processing operation which uses filtering of the stereophonic signal, or
an indication of presence of a binaural signal.

This embodiment makes it possible:
when one or more transitions are detected, to obtain a better rendering on the one or more transitions of the signal by selecting the downmixing operation which does not use filtering and which, as a result, preserves the nature of the stereophonic signal,
when no transition is detected, to favor the downmixing operation which uses filtering, which is better suited to components of the stereophonic signal which are not in phase.

In one embodiment, the detection of said at least one transition is implemented before one or the other of the two downmixing operations is applied to said stereophonic signal.

This embodiment makes it possible, even before a downmixing operation is applied, to deduce a priori that at least one transition is present or not present in the stereophonic signal, without a particular additional processing operation being applied to this signal.

In one embodiment, the detection of said at least one transition is implemented as follows:
calculating the energy of the stereophonic signal, referred to as the input energy, before the filtering is applied,
calculating the energy of the monophonic signal, referred to as the output energy, after the filtering is applied,
calculating a ratio of the input energy and the output energy,
comparing said ratio with an energy threshold, and
if said ratio is below, or above, said energy threshold, the downmixing operation which does not use filtering of the stereophonic signal, or which uses filtering of the stereophonic signal, is selected, respectively.

In one embodiment, said filtering quality level is compared with a filtering quality threshold and, if said filtering quality level is below, or above, said filtering quality threshold, the downmixing operation which does not use filtering of the stereophonic signal, or which uses filtering of the stereophonic signal, is selected, respectively.

In one embodiment, an indicator which is representative of the result of said detection, of the comparison of said ratio with an energy threshold, or of the comparison of the filtering quality level with a filtering quality threshold, is generated.

In one embodiment, the method comprises a preliminary phase of adapting downmixing filters before application to the stereo signal via the following steps:
obtaining impulse responses of the filters corresponding to the downmixing operation;
truncating part of the impulse responses;
weighting the remaining part by applying a weighting window;
normalizing the impulse responses resulting from the windowing to obtain the adapted filters which are to be applied to a stereo signal frame.

In one particular embodiment, the truncating step consists in preserving a causal part and a non-causal part of the impulse responses.

The invention targets a downmixing device comprising a processing circuit for implementing the steps of the downmixing method as described above.

The invention also relates to a computer program comprising instructions for implementing the downmixing method which is in accordance with the invention, according to any one of the particular embodiments described above, when said program is executed by a processor.

Such instructions may be stored durably in a non-transient memory medium of the downmixing device implementing the downmixing method according to the invention.

This program can use any programming language, and be in the form of source code, object code, or intermediate code between source code and object code, such as in a partially compiled form, or in any other desirable form.

The invention also targets a computer-readable storage medium or information medium comprising instructions of a computer program as mentioned above.

The storage medium may be any entity or device which is capable of storing the program. For example, the medium may comprise a storage means, such as a ROM, for example a CD-ROM or a microelectronic circuit ROM, or indeed a magnetic storage means, for example a mobile medium, a hard disk or an SSD.

Moreover, the storage medium may be a transmissible medium such as an electrical or optical signal, which may be routed via an electrical or optical cable, by radio or by other means, such that the computer program which it contains may be executed remotely. The program according to the invention may, in particular, be downloaded from a network, for example an Internet network.

Alternatively, the storage medium may be an integrated circuit into which the program is incorporated, the circuit being adapted to execute or to be used in the execution of the aforementioned downmixing method.

According to one example of an embodiment, the present technique is implemented by means of software components and/or hardware components. With this in mind, the term “device” or “module” may correspond, in this document, equally to a software component, to a hardware component or to a set of hardware components and software components.

### BRIEF DESCRIPTION OF THE DRAWINGS

Other features and advantages of the invention will become more clearly apparent upon reading the following description of particular embodiments, which are given by way of mere illustrative and non-limiting examples, and the appended drawings, among which:

FIG. 1a illustrates channels of a stereophonic signal, in phase as described above;

FIG. 1b illustrates channels of a stereophonic signal, in phase opposition as described above;

FIG. 2 illustrates, in the form of a block diagram, a downmixing sequence in one embodiment of the invention;

FIG. 3 illustrates one embodiment of a filter calculation for the downmixing, as well as a selection of a downmixing operation;

FIG. 4 illustrates one embodiment of a phase of adapting a downmixing filter;

FIG. 5 illustrates one embodiment of a transition of the application of the downmixing during a transition between two frames of stereo signal;

FIG. 6a illustrates another embodiment of a filter calculation for the downmixing, as well as a selection of a downmixing operation;

FIG. 6b illustrates another embodiment of a filter calculation for the downmixing, as well as a selection of a downmixing operation;

FIG. 7 illustrates an existing downmixing procedure described above;

FIG. 8 illustrates one example of a structural embodiment of a downmixing device according to one embodiment of the invention.

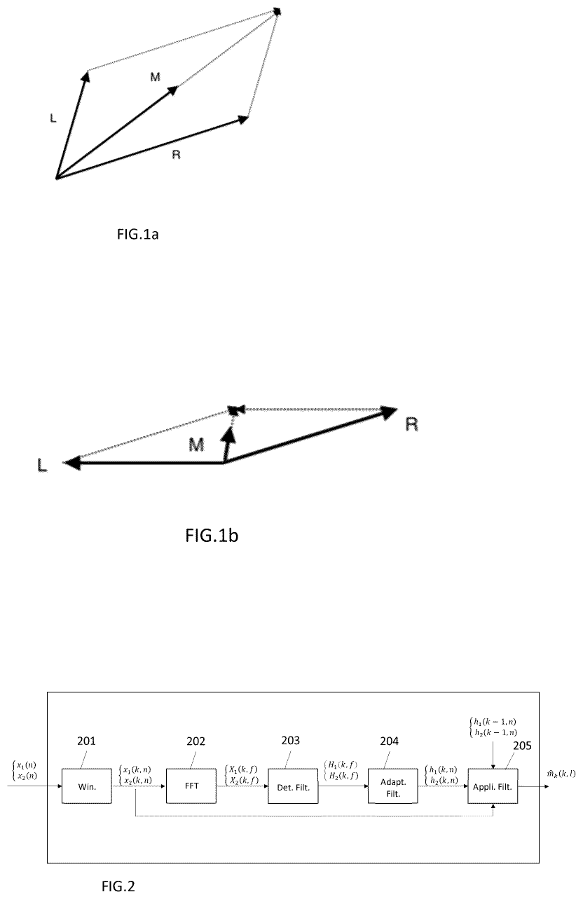

### DESCRIPTION OF THE EMBODIMENTS

The invention will now be described below with reference to FIGS. 2 to 8. To this end, the following symbols will mainly be used in the following description.

### Indices

k frequency index
l temporal index of a signal (in the current frame)
n temporal index of a signal
t frame number

### Constants

L number of samples in the current frame
R filter delay
N FFT length
C number of input channels
D number of output channels
P filter length
Q length of crossfade

### Signals

x₁(n) input channels
m(n) downmixing (in the time domain)
m(t,l) downmixing in the current frame (in the time domain)
M(t,k) downmixing in the current frame (in the frequency domain)

FIG. 2 shows one example of a sequence for processing a stereophonic audio signal, the processing operation comprising a downmixing operation.

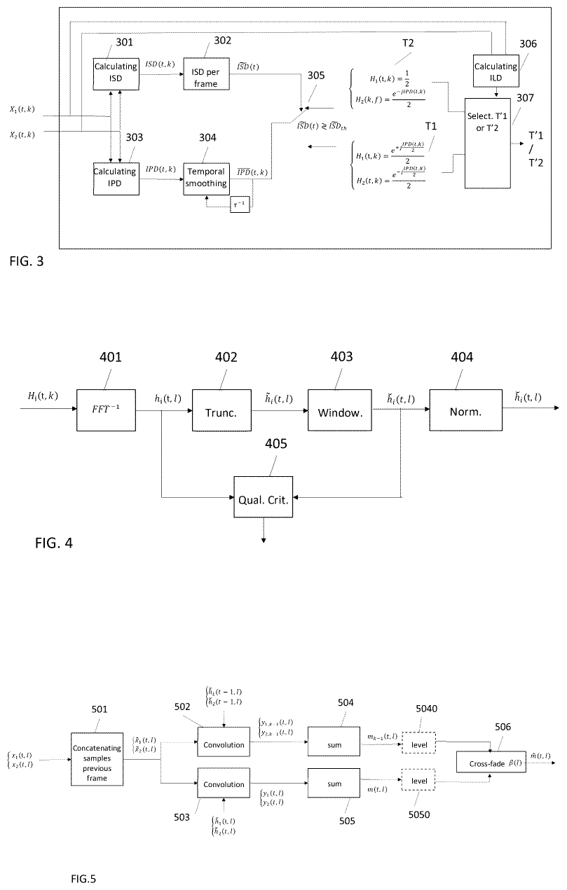

At the input of this processing sequence, a stereophonic signal x, composed of two channels (x₁(n) and x₂(n)), also called the left channel and right channel (respectively), is, in a first stage, divided, in 201, into frames of L samples (x₁(t,l) and x₂ (t,l, t being the index of the frame and 1 the index of the sample. The block 202 applies windowing and an FFT (for fast Fourier transform), in order to obtain signals in the frequency domain (X₁(t,k) and X₂(t,k), k being the index of the frequency). In 203, a downmixing filter to be applied to a signal frame is then selected and determined. This step will be described with reference to FIG. 3. The filter thus determined is conditioned (or adapted) in 204 in order to make it causal or partly causal and optimize it in order to reduce processing complexity. In one example of an embodiment, the windowing and the FFT are similar to the steps 702 and 703 of FIG. 7.

This adaptation phase is described with reference to FIG. 4.

Once the one or more filters have been determined and adapted for the current frame, they are applied, in 205, to this current frame. In order to avoid audible artifacts which are due to a change of filters between two frames, a cross-fade is carried out by taking into account the filters of the previous frame

$$\{ \begin{matrix}{h}_{1} ( t - 1 , l ) \\ {h}_{2} ( t - 1 , l )\end{matrix}$$

when the downmixing of the previous frame is of the same type (T1/T2 defined below).

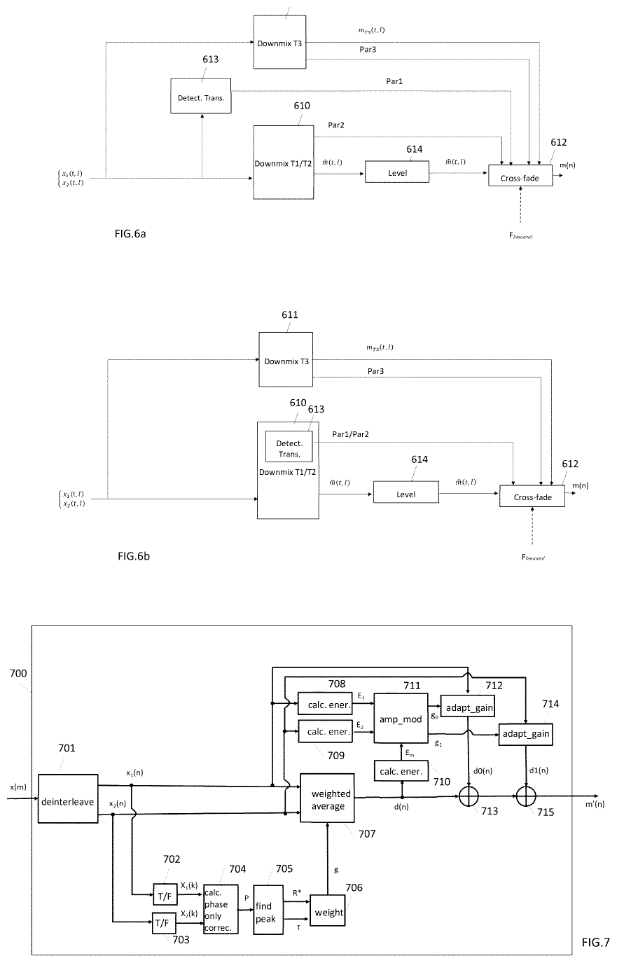

This step will be described with reference to FIG. 5.

FIG. 3 describes a detailed embodiment of the block 203 of FIG. 2. In this processing block, in a first selection step, a first or a second downmixing operation to be applied to a current frame of the stereophonic signal is selected and determined.

A first downmixing procedure T1 is defined here by shifting the left channel and right channel of the stereophonic signal simultaneously by an angle defined by one quarter of the phase difference (IPD) determined between the two channels of the stereo signal. There is thus a downmixing signal, as follows:

$$M ( t , k ) = \frac{{X}_{1} ( t , k ) \cdot {e}^{+ j \frac{IPD ( t , k )}{4}} + {X}_{2} ( t , k ) \cdot {e}^{- j \frac{IPD ( t , k )}{4}}}{2}$$

This procedure makes it possible to avoid degradation of reverberation surplus type generated by conventional downmixing (average of the two signals) or of comb filtering type in the event of a temporal shift between the two channels.

This downmixing thus defined may be seen, in the frequency domain, as filtering according to the following equation:

$$M ( t , k ) = {H}_{1} ( t , k ) \cdot {X}_{1} ( t , k ) + {H}_{2} ( t , k ) \cdot {X}_{2} ( t , k )$$

$$with {H}_{1} ( t , k ) = \frac{{e}^{+ j \frac{IPD ( t , k )}{4}}}{2} and {H}_{2} ( t , k ) = \frac{{e}^{- j \frac{IPD ( t , k )}{4}}}{2} .$$

In another embodiment, the first downmixing procedure T1 is defined by shifting the left channel and right channel of the stereophonic signal simultaneously by an angle defined by half the phase difference (IPD) determined between the two channels of the stereo signal.

$$Then :$$

$$M ( t , k ) = \frac{{X}_{1} ( t , k ) \cdot {e}^{+ j \frac{IPD ( t , k )}{2}} + {X}_{2} ( t , k ) \cdot {e}^{- j \frac{IPD ( t , k )}{2}}}{2}$$

or equivalently:

$$M ( t , k ) = {H}_{1} ( t , k ) \cdot {X}_{1} ( t , k ) + {H}_{2} ( t , k ) \cdot {X}_{2} ( t , k )$$

$$with {H}_{1} ( t , k ) = \frac{{e}^{+ j \frac{IPD ( t , k )}{2}}}{2} and {H}_{2} ( t , k ) = \frac{{e}^{- j \frac{IPD ( t , k )}{2}}}{2} .$$

A second downmixing procedure T2 is, for example, defined as the one proposed in the Samsudin document cited above.

In this second procedure, then,

$${H}_{1} ( t , k ) = \frac{1}{2} and {H}_{2} ( t , k ) = \frac{{e}^{- jIPD ( t , k )}}{2} .$$

As described below, in one embodiment, the corresponding impulse responses, hᵢ(t,l), are in fact shifted in time to keep the causal and anticausal parts. This shift may in variants be integrated directly into the definition of Hᵢ(t,k).

Moreover, in variants, it is possible, equivalently, to remove the factor ½ from the definition of Hᵢ(t,k) and to integrate this factor ½ during the mixing of the channels processed in 504 and 505 (see FIG. 5 described below).

In practice, the phase difference IPD or IPD/4 or IPD/2 does not need to be determined. In an efficient implementation, the filters Hᵢ(t,k) can be determined by normalizing the (complex) frequency lines—with or without smoothing—by their modulus (in the complex-number sense).

The channels of the stereo signal, in the frequency domain (X₁(t,k) and X₂(t,k)), are used, on one hand, to calculate an ISD phase indicator in 301, which is representative of a measure of the degree of phase opposition between the channels of the stereo signal and, on the other hand, the phase difference between the (IPD) channels in 303.

The phase indicator is, for example, defined by the ISD (inter-spectral distance) indicator as defined above.

In the embodiment described here, the ISD is determined by stereophonic signal frame in order for the decision to select a first downmix or a second to be able to be made frame by frame.

This decision by frame makes it possible to dispense with substantial phase shifts between frequencies and with other audible artifacts which may appear when the decision varies from one frequency to the next, as in the patent application cited above.

To apply a decision by frame, a decision criterion according to the ISD phase indicator is defined according to the following equation in 302:

$$\text{?} ( t ) = \frac{total number of frequency lines where ISD ( t , k ) > 1.3}{total number of frequency lines}$$

This criterion measures the percentage of frequency lines of index k for which the criterion is favorable to downmixing with rephasing, that is to say when ISD(t,k)>1.3. The decision is taken to apply the first downmix as defined above, with rephasing, when [symbol] (t) exceeds a certain threshold [symbol] ₜₕ, which is set, for example, at 70%.

In another embodiment, the ISD indicator will potentially be determined in a predefined frequency band:

$$\text{?} ( t ) = \frac{1}{{k}_{max} - {k}_{min} + 1} {\sum }_{k = {k}_{min}}^{{k}_{max}} ISD ( t , k )$$

where, for example, kₘᵢₙ=2 and kₘₐₓ is the number of the frequency line corresponding to a maximum frequency, for example 4 kHz.

In this case, this criterion is an average of the value of the ISD per frequency line. In this variant, the threshold does not correspond to a percentage but to an ISD value, and will for example possibly be set to [symbol] ₜₕ=1.5.

There is then, in 305, the following downmix selection decision between T1 and T2:

$$\{ \begin{matrix}\text{?} ( t ) < \text{?} : {H}_{1} ( t , k ) = \frac{{e}^{+ j \frac{IPD ( t , k )}{4}}}{2} , & {H}_{2} ( t , k ) = \frac{{e}^{- j \frac{IPD ( t , k )}{4}}}{2} \\ \text{?} ( t ) > \text{?} : {H}_{1} ( t , k ) = \frac{1}{2} , & {H}_{2} ( t , f ) = \frac{{e}^{- jIPD ( t , k )}}{2}\end{matrix}$$

In 303, the phase difference IPD is obtained between the two channels of the stereo signal by

$$IPD ( t , k ) = ∠ ( {X}_{1} ( t , k ) \cdot {X}_{2}^{*} ( t , k ) )$$

where ∠ indicates the phase of the complex operand.

However, the frame decision may sometimes be insufficient since the IPD, as calculated according to the above formula, varies very rapidly over time. Also, the filters Hᵢ(t,k) may vary very rapidly from one frame to the next, which generates discontinuities which are sometimes audible during the transition from one frame to the next.

To limit this effect, according to a first approach, the IPD will potentially be calculated in frequency sub-bands rather than in each band independently, while averaging each channel over wider sub-bands. A number B of sub-bands of width equal to B_{K}=K/B will potentially be chosen, where B is an integer greater than or equal to 1. To calculate the IPD in each sub-band b, initially the spectra X̅ᵢ(t,b) in each sub-band are calculated by averaging:

$${\overline{X}}_{i} ( t , b ) = {\sum }_{i = 0}^{{B}_{K} - 1} X ( t , i + b * {B}_{k} )$$

The average spectra of the sub-bands corresponding to the frequency of zero (b=0) and the frequency Fe/2 (b=B/2) are processed separately by direct deduction from the spectra in these frequency bands:

$${\overline{X}}_{i} ( t , 0 ) = {X}_{i} ( t , 0 )$$

$${\overline{X}}_{i} ( t , B / 2 ) = {X}_{i} ( t , K / 2 )$$

The number B of sub-bands is to be determined experimentally. It is necessary to maintain a sufficient frequency resolution to be able to apply suitable rephasing to the various sources: in practice, a frequency resolution of about one hundredth of a hertz seems a good sub-band width. For example, for a stereo signal sampled at 32 kHz, with an FTT size of 640, this resolution corresponds to a number B=320 of sub-bands with B_{K}=² frequency bands in each sub-band.

In variants, the sub-bands may be divided in such a way as to have a non-uniform width, for example according to the Bark scale.

Next, IPD is calculated in the same way as above, i.e.:

$$IPD ( b ) = ∠ ( {\overline{X}}_{1} ( b ) \cdot {\overline{X}}_{2}^{*} ( b ) )$$

Below, the index k will indicate either a frequency band or a frequency sub-band, the case B_{K}=1 being equivalent to carrying out processing in each frequency band separately.

Again to limit the effect of rapid variations in IPD, a version of the IPD that is smoothed in time will potentially be used to calculate the filters Hᵢ(t,k). One way of smoothing the IPD is to apply 1st-order IIR low-pass filtering, in 304, such that:

$$\overline{IPD} ( t , k ) = α ( k ) \overline{IPD} ( t , k ) + ( 1 - α ( k ) ) IPD ( t , k )$$

The forgetting coefficient α(k) is chosen ad hoc. It may be advantageous to choose a high forgetting coefficient at lower frequencies, typically below 5 kHz, since this makes it possible to maintain phase coherence in the lower part of the spectrum from one frame to the next, the spectrum of the speech signals being stationary, notably in its lower part and the particular ear which is sensitive to the phase in this part of the spectrum. By contrast, it is advantageous to choose a low forgetting coefficient at higher frequencies: at higher frequencies, typically above 5 kHz, the phase continuity of the speech signals is less marked and the ear is less sensitive to phase discontinuities in this part of the spectrum.

A forgetting coefficient of the following form may be chosen:

$$α ( k ) = \{ \begin{matrix}{α}_{max} , & k < {k}_{low} \\ {α}_{min} , & k > {k}_{high} \\ {α}_{min} + \frac{k - {k}_{low}}{{k}_{high} - {k}_{low}} , & {k}_{low} < k < {k}_{high}\end{matrix}$$

The values αₘₐₓ, αₘᵢₙ, khigh and kio_{w} are determined experimentally. In the case of adjacent frames of length L=20 ms, the following set of parameters may, for example, be chosen:

$${α}_{ma x} = 0.94 , {α}_{m i n} = 0.86 , {k}_{low} = 0 , {k}_{h igh} , corresponds to 5 kHz .$$

In some variants, very low frequencies and very high frequencies will be forced to remain intact. Thus, in some variants,

$${H}_{1} ( t , k ) = {H}_{2} ( t , k ) = \frac{1}{2}$$

is forced for the first lines k=0 or k=0.1 as well as forced lines of index k>kₘₐₓ, where k corresponds to 8 kHz.

Downmixing with rephasing (T1 or T2) can sometimes substantially alter timbre and cause a decrease in signal quality. These alterations of timbre are particularly audible when a signal is predominant on either channel, i.e. when the ILD (standing for Interchannel Level Difference) measuring the energy ratio between the left channel and right channel is close to 0 or much higher than 1. This is for example the case of a preponderant signal on the right channel to which the mode T1 of rephasing based on IPD is applied. To limit these alterations of timbre it is advantageous, when the energies of the left channel and right channel are very different, to avoid rephasing by applying conventional downmixing.

In a first implementation, an independent decision will potentially be made in each frequency band, this allowing various sources (one of which may be preponderant on one channel and not require rephasing, while the others are distributed between the left channel and right channel and require rephasing) to be processed independently. In this case, a passive downmixing will be forced only on frequency bands exhibiting a high energy disparity:

$${H}_{1} ( t , k ) = {H}_{2} ( t , k ) = \frac{1}{2} , ∀ k , if ILD ( t , k ) > {α}_{ILD} or ILD ( t , k ) < 1 / {α}_{ILD}$$

where

$$ILD ( t , k ) = \frac{{\vert {X}_{1} ( t , k ) \vert}^{2}}{{\vert {X}_{2} ( t , k ) \vert}^{2}}$$

and α_{ILD} is an ILD threshold defined experimentally. In practice, a value of about 100 (20 dB) will possibly be chosen.

Thus, the ILD is calculated in 306 in order to implement a second selection step in 307 and thus determine the downmixing to be applied with or without rephasing T1, T′1, T2 or T′2 according to the frequency bands.

The decision to apply passive downmixing independently in each sub-band can sometimes cause phase fluctuations from one frame to another: this is particularly audible when few frequency bands are involved. To avoid these fluctuations, application of passive downmixing will potentially be limited to the relevant bands only if a sufficient number of relevant bands are observed, indicative of the actual presence of a source to the left or right. In practice, it is possible to calculate the percentage of relevant bands ILD_{prc}(t), and limit application of passive downmixing to the relevant bands defined above to the case where this percentage is greater than a predefined threshold α_{ILDprc}, or:

$${ILD}_{prc} ( t ) = \frac{number of bands where ILD ( t , k ) > {α}_{ILD} or ILD ( t , k ) < 1 / {α}_{ILD}}{total number of frequency bands}$$

and α_{ILDprc} is an experimentally determined threshold. In practice, a threshold of 30% is a good compromise.

FIG. 4 presently details the block 204 of FIG. 2. The filters Hᵢ(t,k), such as for example defined in the downmixing procedures T1 and T2 defined above, are reconditioned or indeed adapted in order to avoid circular convolution.

In a first step, in 401, the impulse responses hᵢ(t,l) of the filters Hᵢ(t,k) are calculated, such that:

$${h}_{i} ( t , l ) = {FFT}^{- 1} \{ {H}_{i} ( t , k ) \} , i = 1 , 2$$

where the filters hᵢ(t,l) are of size Lₕ=B.

In the preferred embodiment, L=20 ms, i.e. K=320 samples at 16 kHz, 640 samples at 32 kHz and 960 samples at 48 kHz, and B_{K}=², i.e. B=160 samples at 16 kHz, 320 samples at 32 kHz and 480 samples at 48 kHz.

The impulse responses thus defined are conventionally non-causal, they correspond to finite impulse response filters. One conventional technique for making them causal consists in a rotation of B/2 samples in order to center the response in B/2. The drawback is that the filter thus reconstructed then exhibits a latency of B/2.

In the preferred embodiment, the impulse response will be truncated:

$${\tilde{h}}_{i} ( t , l ) = \{ \begin{matrix}{h}_{i} ( t , l - M ) , & M \leq l < P \\ {h}_{i} ( t , B - M + l ) & 0 \leq l < M\end{matrix}$$

This (circular) time shifting operation can also be implemented by applying an appropriate phase term to Hᵢ(t,k) before inverse FFT, as known to those skilled in the art. In this embodiment, the obtained filter has a finite impulse response with a delay of R samples. This delay allows the truncated filter to be correctly conditioned, either in terms of gain by minimizing the influence of truncation on the unit gain of the phase-shifting filter, or in phase by minimizing the deviation from the IPD. This delay R can be adapted depending on implementational constraints: in practice, a delay of about one millisecond is sufficient to correctly condition the truncated filter.

In an extreme variant, the truncation is asymmetrical to avoid this latency. The choice is made to truncate the filter asymmetrically, in 402, retaining only a portion of the first half of the impulse response hᵢ(t,l) as follows:

$${\tilde{h}}_{i} ( t , l ) = {h}_{i} ( t , l ) , 0 \leq l < P \leq B / 2$$

This filter exhibits the advantage of generally having a maximum (in absolute value) on its first sample, which guarantees processing without an additional delay. In terms of frequency response, it exhibits a phase which is almost equal to the optimal rephasing filter hᵢ(t,l). The fact that the anticausal part of the impulse response is removed may optionally be compensated for by in addition applying a factor 2 to the values of hᵢ(t,l) for l>0. In this variant, the obtained filter has a finite impulse response with virtually no delay.

The choice of P depends on various criteria: a value of P which is close to N/2 guarantees near-optimal rephasing, whereas a lower value makes it possible to limit the computational power which is necessary for filtering. A low value of P also results in smoothing the phase of the filter. This exhibits an advantage with filters defined by the processing operation T2 as defined above, where the phase varies very rapidly from one frequency to the next: these variations may result in a very high group delay which is perceptible to the human ear. A low value of P makes it possible to remove all or some of these artifacts.

The filter thus truncated \tilde{h}ᵢ(t,l), notably when P<N/2, or even P<<N/2, exhibits an impulse response tail which does not tend toward 0. This creates audible clicking discontinuities at the transition between 2 frames. Thus, in order to avoid these audible artifacts, \tilde{h}ᵢ(t,l) is weighted with a window w(l), in 403, such that:

$$\check{h} ( t , l ) = w ( l ) \cdot {\tilde{h}}_{i} ( t , l )$$

where the coefficients of w(l) tend to 0 when 1 tends to 0 or P and are equal to 1 when l=R. This makes it possible to reduce the energy of the samples at the end of the filter and to avoid discontinuities during the transition between filters of consecutive frames.

In the preferred embodiment, in which the truncation preserves an anticausal part, triangular windows are for example applied to the causal and anticausal parts

$$w ( l ) = \{ \begin{matrix}\frac{l}{R} , 0 \leq 1 < R \\ 1 - \frac{R - l}{R - P} , R \leq 1 < P\end{matrix}$$

or any other type of window, a Hann window for example.

In the variant where the truncation is asymmetric, this window may be a triangular half-window, or indeed a Hann half-window:

$$w ( l ) = 1 - l / P , or cos ( l π / 2 P )$$

On account of its truncation and the windowing, the filters \tilde{h}ᵢ(t,l) have a reduced energy with respect to that of the optimal filter hᵢ(t,l): the latter, as a pure phase-shifting filter, has a norm ½ by construction. Thus, the energy of the filter thus truncated and windowed may be normalized, in 404, such that:

$${{h}^{⌣}}_{i} ( t , l ) = \frac{{\check{h}}_{i} ( t , l )}{2 ‖ {\check{h}}_{i} ( t , l ) ‖}$$

where ∥x(⋅)I∥ is the norm 2 of a vector.

In variants, another procedure may be used in 204 instead of the procedure of FIG. 4. For example, the impulse response will possibly be determined directly by least squares minimization and matrix inversion using the (complex) Levinson algorithm as described in section 2 of the article by Mathias C. Lang, Design of nonlinear phase FIR digital filters using quadratic problems, Proc. ICASSP, 1997. The interested reader may for example find an instance of this procedure in the thesis by Mathias C. Lang, Algorithms for the Constrained Design of Digital Filters with Arbitrary Magnitude and Phase Responses, June 1999 (see routine levin.m in Appendix B and lslevin.m in Section 2.1.4). In this case an inverse FFT, truncation and weighting are not necessary; this alternative procedure estimates a finite impulse response of length P directly (without guarantee of a minimum phase). However, a normalization taking the following form will potentially be applied:

$${{h}^{⌣}}_{i} ( t , l ) = \frac{{\check{h}}_{i} ( t , l )}{2 ‖ {\check{h}}_{i} ( t , l ) ‖}$$

According to the invention, in 405, a quality level of the filtering which has been implemented is determined. In the preferred embodiment with a truncation with a causal part, the level of |ȟᵢ(t,l)| will potentially be determined for l=R. When this value is less than a predetermined threshold (for example 0.25), this indicates a low quality criterion, and conversely, when this value is greater than a predetermined threshold (for example 0.25), this indicates a good quality criterion.

In some variants, it is possible to determine to this end:
an energy E₄₀₁ of the filter before truncation 402 is calculated;
an energy E₄₀₃ of the temporal filter after windowing 403 is calculated;
a ratio R₄ between E₄₀₁ and E₄₀₃ is calculated.

A filtering quality may also be determined by comparing an energy E₄₀₁ and an energy E₄₀₄ of the temporal filter after normalization.

By way of non-exhaustive alternatives, the quality level of filtering may be determined:
directly on the filter Hᵢ(t,k), and/or
a frequency version of this same filter before normalization \tilde{H}ᵢ(t,k) or after normalization \tilde{H}ᵢ(t,k).
etc.

In other variants, it is possible to calculate:

$${\sum }_{l = 0}^{P - 1} {( {h}_{i} ( t , l ) - {\check{h}}_{i} ( t , l ) )}^{2}$$

This criterion may be normalized by:

$${\sum }_{l} {{h}_{i} ( t , l )}^{2}$$

Another variant of quality may be concerned with measuring the amount of energy lost during truncation in order to make the filter causal. In this variant, E₄₀₁ may be calculated as the “anticausal” energy of the original filter:

$${E}_{401} ( t ) = {\sum }_{l = N / 2}^{N - 1} {h}_{i}^{2} ( t , l )$$

The energy E₄₀₃ (or E₄₀₄) may be calculated as the energy of the synthesized filter, before normalization (or after normalization):

$${E}_{403} ( t ) = {\sum }_{l = 1}^{P - 1} {\check{h}}_{i}^{2} ( t , l ) \\ {E}_{404} ( t ) = {\sum }_{l = 1}^{P - 1} {\breve{h}}_{i}^{2} ( t , l )$$

In order to avoid the bias linked to the size of the window, the energy of the anticausal part may also be calculated over the same number of samples, with or without windowing by the window w(l):

$${E}_{401} ( t ) = {\sum }_{l = N / 2 - P}^{N - 1} {h}_{i}^{2} ( t , l ) \\ {E}_{401} ( t ) = {\sum }_{l = N - P}^{N - 1} w ( N - l + P ) {h}_{i}^{2} ( t , l )$$

In some variants, the frequency response \tilde{H}ᵢ(t,k) of the filter obtained after truncation (at the output of 403) may be calculated and compared with the target response Hᵢ(t,k) in order to define the quality level, for example:

$${\sum }_{k} {\vert {H}_{i} ( t , k ) - {\check{H}}_{i} ( t , k ) \vert}^{2}$$

This criterion may be normalized by:

$${\sum }_{k} {\vert {H}_{i} ( t , k ) \vert}^{2}$$

Another variant of the quality criterion may consist in comparing the phase coherence of the filters, given that the objective is to rephase signals. Thus, the coherence C_{H}_{ᵢ}_{,\tilde{H}}_{ᵢ}(t) between the 2 filters may be calculated:

$${C}_{{H}_{i} , {\check{H}}_{i}} ( t ) = \frac{1}{N} \vert {\sum }_{k} \frac{{H}_{i} ( t , k ) {\check{H}}_{i}^{*} ( t , k )}{\vert {H}_{i} ( t , k ) {\check{H}}_{i}^{*} ( t , k ) \vert} \vert$$

A high coherence (i.e. which is close to 1) indicating that the synthesized filter is close to the ideal filter and therefore a high quality factor, a low value (which is close to 0) indicating, by contrast, a low quality criterion.

FIG. 5 presently describes the block 205 of FIG. 2, where an OLS (overlap-save) implementation of the filtering is performed in the time or frequency domain, in detail. The choice of domain will be made depending on complexity, which depends on the size of the filter relative to that of the frame to be processed.

An OLS implementation in the time domain is presented here, with adjacent frames of size L.

In a first stage, the current frame is concatenated, in 501, with the P-1 samples of the previous frame (save principle:

$${\tilde{x}}_{i} ( k , . ) = [ {x}_{i} ( tL - P + 2 ) , … , {x}_{i} ( tL - 1 ) , {x}_{i} ( tL ) , … {x}_{i} ( ( t + 1 ) L - 1 ) ]$$

Each channel is filtered by its phase-shifting filter in 503:

$${y}_{i} ( t , l ) = {\sum }_{p = 0}^{P - 1} {\breve{h}}_{i} ( t , p ) \cdot {\tilde{x}}_{i} ( t , l + P - p ) , 0 \leq l < L$$

The mono downmix is then created by summing the two channels rephased in 505:

$$m ( t , l ) = {y}_{1} ( t , l ) + {y}_{2} ( t , l ) , 0 \leq l < L$$

In practice, the filters may be very different between two successive frames, for example when a new source appears. In this case, the transition between mₜ₋₁(t,l) and m(t,l) may occasion differences in the form of audible artifacts. To avoid these artifacts, a cross-fade step may be applied. In order to carry out this cross-fading, the filters ȟᵢ(t−1,l) are applied to the current frame over a number of samples Q:

$${y}_{i , t - 1} ( t , l ) = {\sum }_{p = 0}^{P - 1} {\breve{h}}_{i} ( t - 1 , p ) \cdot {\tilde{x}}_{i} ( t , l + P - p ) , 0 \leq l < Q$$

This is carried out by the block 502 of FIG. 5.

The number of samples which are necessary for the cross-fading will have to be determined experimentally, depending on the size of the filters, on the sampling frequency etc.

Next, the mono downmix mₜ₋₁(t,l) is created in 504, on the basis of filters of the previous frame:

$${m}_{t - 1} ( t , l ) = {y}_{1 , t - 1} ( t , l ) + {y}_{2 , t - 1} ( t , l ) , 0 \leq l < Q$$

The signal resulting from the downmix \hat{m}(t,l) is created in 506, on the basis of a cross-fade according to the following equation:

$$\hat{m} ( t , l ) = \{ \begin{matrix}β ( l ) \cdot {m}_{t - 1} ( t , l ) + ( 1 - β ( l ) ) \cdot m ( t , l ) , & 0 \leq l < Q \\ m ( t , l ) , & Q \leq l < L\end{matrix}$$

where β(l) is a decreasing monotonic function, with β(0)=1 and β(Q−1)=ε with ε being a value which is close to 0 or is zero. Typically, a Hann half-window may be chosen:

$$β ( l ) = cos ( \frac{l π}{2 Q} ) , 0 \leq l < Q$$

It should be noted that, in an integration with other downmixing procedures, the aforementioned downmixing procedures T1 and T2 cannot always be represented by a filtering operation. This is the case for the procedure T3 of FIG. 7 or any other procedure the gain of which depends on the instantaneous level of the signal.

In the preferred embodiment, the procedure T3 of FIG. 7 is modified to add a time shift (delay) so as to synchronize the output downmixing with the downmixing of the procedures T1/T2. In addition, energy compensation is applied to the procedure T3 in the same way as to the procedures T1/T2 to ensure consistency in level and allow a better transition between procedures.

According to the invention, in the case where a selection of the downmixing procedures T1 and T2 or the downmix T3 is implemented, as will be described in the remainder of the description, a step 5040 and 5050 of scaling each of the signals mₜ₋₁(t,l) and m(t,l), respectively, is implemented. To this end, the signal m′(n) obtained at the output of the downmix T3 of FIG. 7 having a level N3, the level N1, or N2, of each of the signals mₜ₋₁(t,l) and m(t,l) to which the downmix T1, or T2, has been applied is adjusted to the level N3, so as to be equal or similar to this level N3. Instead of being applied to each of the signals mₜ₋₁(t,l) and m(t,l), such scaling can also be carried out on the signal \hat{m}(t,l).

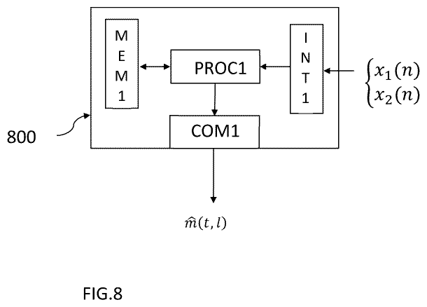

FIG. 6a presently details a downmixing method which is in accordance with the invention, wherein one of the downmixing procedures T1 or T2 (or T′1/T′2 in the second selection step) chosen at the end of the selection method of FIG. 3 is implemented in 610, and another downmixing procedure is implemented in 611, the gain of which depends on the instantaneous level of the signal, such as, for example, the procedure T3 of FIG. 7.

In this case, one solution is to calculate the downmixes of each procedure for the current frame of temporal index 1 and to perform a transition, in 612, from one downmix to the next by cross-fading, which generates a monophonic signal m(n). More specifically, in the case of a transition from a downmix T1 (or T2) to the downmix T3, the downmixing may be performed between the signal \hat{m}(t,l) obtained at the output of T1 (or T2) and the signal m_{T3}(t,l) obtained at the output of T3. The cross-fading may also be performed between the output of T1 (or T2) and the signal d(n) as described in FIG. 7. In this latter case, the energy compensation of the procedure T3 (adapt_gain in FIG. 7) would be applied to all the procedures continuously. The decision to switch from one downmix T1 or T2 to a downmix T3 (which is a third selection step) may be motivated by a criterion such as the ISD, which was defined above, or by other criteria, for example parameters Par3 already calculated by the procedure T3, such as for example the ITD, by choosing to apply the downmix T3 by default when the ITD is very large (for example, ITD>600 microsec in absolute value). The ILD(t) criterion can also be used when one channel is much higher in level than the other (case of an absence of signal to the left or right for example): downmixing without rephasing will be preferred to avoid any loss of timbre. Other criteria or combinations of criteria could also be used.

In particular, the third step of selection of the downmix T1 (or T2) or T3 is implemented depending on:
a presence or absence of at least one transition in the stereophonic signal, or
a quality level of the filtering of the stereophonic signal used when the downmix T1 (or T2) is implemented, or
an indication of presence of a binaural signal. This latter indication is external information F_{binaural} (for example defined as a binary value: 1=binaural, 0=other) that explicitly indicates that the input signal is binaural.

In the case of a detection 613 of the presence or absence of at least one transition in the stereophonic signal, according to a first embodiment, detection of a transient is applied separately to each of the input signals x₁(n) and x₂ (n), or to the current frame x₁(t,l) and x₂(t,l). Since the detection of transients is a conventional problem in audio coding, the example of the module already implemented in the EVS codec and described in the 3GPP standard TS 26.445 clause 5.1.8 is taken. To this end, each of the input signals x₁(n) and x₂(n), or the current frame x₁(t,l) and x₂(t,l) is divided into sub-blocks. The energy of each sub-block is calculated, then smoothing is optionally implemented. The energy obtained is then compared with an energy threshold th₆₁. If this energy obtained is below th₆₁, the presence of a transition is considered to be not detected. If this energy obtained is above th₆₁, the presence of a transition is considered to be detected. To this end, a parameter Par 1 (if T1 was chosen at the end of the selection of FIG. 3) or Par2 (if T2 was chosen at the end of the selection of FIG. 3) is set:
to a first value, for example 0, in order to indicate that the presence of a transition has not been detected,
to a second value, for example 1, in order to indicate that the presence of a transition has been detected.

Such a parameter Par1/Par2 is transmitted, as a decision criterion, to the cross-fading block 612.

In the case where the downmix T1 (or T2) or the downmix T3 is selected based on a quality level of the filtering of the stereophonic signal used when the downmix T1 (or T2) is implemented, with reference to FIG. 4, the following steps are implemented:
calculating the energy E₆₁ of the signal hᵢ(t,l),
calculating the energy E₆₂ of the signal \tilde{h}₁(t,l),
calculating a ratio between E₆₁ and E₆₂,
comparing said ratio with an energy threshold SE.

If the ratio between E₆₁ and E₆₂ is below SE, the presence of a transition is considered to not be detected. If the ratio between E₆₁ and E₆₂ is above SE, the presence of a transition is considered to be detected. To this end, a parameter Par 1 (if T1 was chosen at the end of the selection of FIG. 3) or Par2 (if T2 was chosen at the end of the selection of FIG. 3) is set:
to a first value, for example 0, in order to indicate that the presence of a transition has not been detected,
to a second value, for example 1, in order to indicate that the presence of a transition has been detected.

Such a parameter Par1/Par2 is transmitted, as a decision criterion, to the cross-fading block 612.

Thus, according to the invention, when a transient is detected in the current frame in one or both channels, the downmix T3 is applied to the current frame rather than the downmix T1 (or T2). Specifically, the downmixes T1 and T2 use filtering by an impulse response which sometimes has a tendency to spread the envelope of the signal; this problem is more pronounced in transient sounds such as castanets, scissors clicking on a binaural recording simulating a haircut at a hairdresser's etc.

When external information F_{binaural} explicitly indicates that the signal with 2 input channels is binaural, i.e. F_{binaural}=1, it is possible according to the invention to choose a particular downmix, for example the downmix T3.

In order to limit potential artifacts due to the cross-fading (block 612) between downmixing procedures, the invention may make provision for applying, in 614, scaling of the signal at the output of T1 (or T2). According to the invention, such scaling 614 implements the following steps:
determining the energy E′ of the downmixing signal at the output of T1 (or T2), preferably with smoothing, by carrying out the same steps as the steps 708, 709 and 710 of FIG. 7,
determining the scale factor:

$${g}^{′} = \sqrt{\frac{{E}_{1} + {E}_{2}}{2 {E}^{′}}}$$

applying the factor g′ to said downmixing signal by returning to the principle of operation (with smoothing at the start of the frame) of the blocks 712 and 714 of FIG. 7.

Unlike the downmix in FIG. 7, a direct compensation of the level of the downmix at the output of T1 or T2 is applied here, without reinjecting an input signal.

It will be noted that when the downmix T1 or T2 introduces a delay, the energy compensation must take this delay into account so as to align the energy of the downmix as a function of input channels. This can be achieved by shifting the input channels to synchronize them with the downmix. In variants, equivalently, the energy used for the energy compensation can also be calculated per sub-block. For example, with a delay R=1 ms, it is possible to divide the frame of 20 ms into 20 sub-blocks and to take the energy of the last sub-block of the previous frame and the first 19 sub-blocks of the current frame for the input channels.

FIG. 6b illustrates one alternative to the downmixing method described with reference to FIG. 6A.

The embodiment illustrated in FIG. 6B is distinguished from that of FIG. 6A only by the fact that a transition is detected according to a second embodiment. According to this second embodiment, such detection is implemented during the step 610 of downmixing T1 (or T2) instead of being applied separately to each of the input signals x₁(n) and x₂(n), or to the current frame x₁(t,l) and x₂(t,l). To this end, with reference to FIG. 5, the energy of each 2-ms sub-block is compared between the input and output signal of the blocks 502 and 503. If the energy has lowered a threshold, for example 3 dB, it is considered that a transient has been greatly attenuated, and in this case the downmix T3 is applied in the current frame. If the energy has not lowered a threshold, for example 3 dB, it is considered that a transient has not been attenuated, and in this case the downmix T1 (or T2) is applied in the current frame.

Once again, when external information F_{binaural} explicitly indicates that the signal with 2 input channels is binaural, i.e. F_{binaural}=1, it is possible according to the invention to choose a particular downmix, for example the downmix T3.

FIG. 8 illustrates a downmixing device 800, within the meaning of the invention.

The device 800 comprises a processing circuit typically including:
a memory MEM1 for storing instruction data of a computer program within the meaning of the invention;
an interface INTl for receiving a stereo audio signal

$$\{ \begin{matrix}{x}_{1} ( n ) \\ {x}_{2} ( n )\end{matrix} ;$$

a processor PROC1 for receiving this signal and processing it by executing the computer program instructions which the memory MEM1 stores, with a view to carrying out downmixing; in particular, the processor being able to control the processing modules as described with reference to FIGS. 2 to 5; and
a communication interface COM 1 for transmitting the reduced signals, resulting from the downmixing, \hat{m}(t,l), to another processing module, for example a coding or decoding module of an audio signal coder or decoder.

Of course, this FIG. 8 illustrates one example of a structural embodiment of a downmixing device within the meaning of the invention.

FIGS. 2 to 7, commented on above, describe functional embodiments of this device in detail.

The applications of this type of downmixing are, for example, in audio coding, for example when the remote does not have the capabilities for rendering stereo sound on its terminal. In this case, it is not necessary to transport a stereo signal, and this makes it possible to save bandwidth. This type of method may operate during point-to-point conversations if one of the participants makes a stereo or binaural sound recording. This type of method may also be present during a multiparty call: the conference bridge spatializes the scene by creating a stereo scene, but not all the participants necessarily have stereo rendering capabilities. The scene should then be downmixed in mono for these participants.

The invention may also apply to audio decoding: in this case, it is the renderer (rendering module) of the user which will downmix the stereo content in order to adapt to the reduced capabilities of the user (a mere loudspeaker, for example).

1. A method for downmixing a stereophonic signal in order to obtain a monophonic signal, the method being performed by a downmixing device and comprising, for a current frame:
a first step of selecting a downmixing operation from first and second procedures which use filtering of the stereophonic signal and rephasing of the signals, the selection being made according to a phase indicator, representative of a measure of a degree of phase opposition between the frequency components of channels of the stereophonic signal; and
a second step of selecting between one of the first and second procedures, selected at the end of the first selection step, and a downmixing procedure without rephasing, the selection being made according to a value of an energy ratio between the channels of the stereophonic signal.

2. The method as claimed in claim 1, wherein the energy ratio between the channels of the stereophonic signal is calculated per frequency band, the second selection step being performed per frequency band.

3. The method as claimed in claim 2, wherein the downmixing operation without rephasing is selected for relevant frequency bands only in a case where a number of relevant frequency bands exceeds a threshold.

4. The method as claimed in claim 1, further comprising a third step of selection between one of the first and second procedures selected at the end of the second selection step and a third downmixing procedure which does not use filtering of the stereophonic signal, said third step of selection being implemented depending on:
a presence or absence of at least one transition in the stereophonic signal, or
a quality level of the filtering of the stereophonic signal used when implementing a processing operation which uses filtering of the stereophonic signal, or
an indication of presence of a binaural signal.

5. The method as claimed in claim 4, wherein, if a presence of said at least one transition is detected, or not detected, in the stereophonic signal, the downmixing operation which does not use filtering of the stereophonic signal, or which uses filtering of the stereophonic signal, is selected, respectively.

6. The method as claimed in claim 4, wherein said at least one transition is detected before one of the first or second procedures is applied to said stereophonic signal.

7. The method as claimed in claim 4, wherein the method comprises detecting said at least one transition as follows:
calculating an energy of the stereophonic signal, referred to as input energy, before the filtering is applied,
calculating an energy of the monophonic signal, referred to as output energy, after the filtering is applied,
calculating a ratio of the input energy and the output energy,
comparing said ratio with an energy threshold, and
if said ratio is below, or above, said energy threshold, the downmixing operation which does not use filtering of the stereophonic signal, or which uses filtering of the stereophonic signal, is selected, respectively.

8. The downmixing method as claimed in claim 4, comprising comparing said filtering quality level with a filtering quality threshold and, if said filtering quality level is below, or above, said filtering quality threshold, the downmixing operation which does not use filtering of the stereophonic signal, or which uses filtering of the stereophonic signal, is selected, respectively.

9. The method as claimed in claim 1, wherein the method comprises a preliminary phase of adapting downmixing filters before application to the stereophonic signal via:
obtaining impulse responses of the filters corresponding to the downmixing operation;
truncating part of the impulse responses;
weighting a remaining part of the impulse responses by applying a weighting window;
normalizing the impulse responses resulting from applying the weighting window to obtain adapted filters which are to be applied to a stereophonic signal frame.

10. The method as claimed in claim 9, wherein the truncating comprises preserving a causal part and a non-causal part of the impulse responses.

11. A downmixing device comprising:
a processing circuit which is configured to implement a method for downmixing a stereophonic signal in order to obtain a monophonic signal, the method comprising, for a current frame:
a first step of selecting a downmixing operation from first and second procedures which use filtering of the stereophonic signal and rephasing of the signals, the selection being made according to a phase indicator, representative of a measure of a degree of phase opposition between the frequency components of channels of the stereophonic signal; and
a second step of selecting between one of the first and second procedures, selected at the end of the first selection step, and a downmixing procedure without rephasing, the selection being made according to a value of an energy ratio between the channels of the stereophonic signal.

12. A non-transitory computer readable storage medium storing a computer program comprising instructions for executing a method for downmixing a stereophonic signal in order to obtain a monophonic signal, when the instructions are executed by at least one processor of a downmixing device, wherein the method comprises, for a current frame:
a first step of selecting a downmixing operation from first and second procedures which use filtering of the stereophonic signal and rephasing of the signals, the selection being made according to a phase indicator, representative of a measure of a degree of phase opposition between the frequency components of channels of the stereophonic signal; and
a second step of selecting between one of the first and second procedures, selected at the end of the first selection step, and a downmixing procedure without rephasing, the selection being made according to a value of an energy ratio between the channels of the stereophonic signal.
